(19) United States
(12) Patent Application Publication
(10) Pub. No.: US 2002/0134215 A1
(43) Pub. Date: Sep. 26, 2002

(54) Sprada banjo baffles, and tailpiece

(76) Inventor: Gilfred Lyle Spradlin SR., N. FT. Myers, FL (US)

Correspondence Address: GILFRED L. SPRADLIN SR., PO. BOX 3267, NORTH FORT MYERS, FL, 33918-3267, US

(21) Appl. No.: 09/921,688

(22) Filed: Aug. 6, 2001

Related U.S. Application Data
(60) Provisional application No. 60/224,797, filed on Aug. 14, 2000.

(51) Int. Cl. G10D 1/10

(52) U.S. Cl. 84/270

(57) ABSTRACT

My inventions are: three concentric baffles, plus one non-resonant tailpiece assembly.

FIG. (3) Bottom deflecting baffle. drawing sheets, −1,2,AND 3

FIG. (4) Middle detoning baffle, ″ ″ ″ ″ ″ ″

FIG. (5) Top detoning baffle, ″ ″ ″ ″ ″ ″

FIG. (1) Non-resonant tailpiece assembly. drawing sheet, No.3

All three baffles are joined together, as one whole, designed to deflect, and project sound; guiding the path of, sound in a (360) degree radius, VI-A the banjo head, FIG.(6) to the tone ring, FIG. (8) thus, having a clarity a volume sound, and a clarity of tone, continue on, by-passing, the outer edge of the baffles plane surface, spreading out striking the resonator, FIG. (13) bounces back, then exhausts out through, the (22) holes of the flange plate, FIG. (14).

Illustration, FIG. (16) drawing sheet number, (4).

Please note: all moment of sound, and charity of tone, described in the above paragraph, occurs in sequence, moving, at the rated speed of sound. synopsis when using my inventions, the clarity of tone, (30) percent, and the volume of sound, (8) points, on the decibel meter.

### BACKGROUND OF THE INVENTIONS

1. Description of Prior Art

Subject spread banjo baffles, and tailpiece.

For many, many years banjo manufacturers have failed to concentrate, on the most important part of the banjo, that part-is the tone ring,FIG. (8) also, the heaviest part, they have, failed to enhance, or extract, all of the tone clarity, that-the tone ring, FIG. (8) is capable of producing.

Having, owned, played, and repaired banjos for more than (63) years; I retired in (1990), and concentrated on how, —and in what way I could help the tone ring, FIG. (8),—reach its zenith, of potentiality. continuing to concentrate, and making many, many errors, I finally succeeded, filed a provisional, application, AUG. 14, 2000.

Please note; I would like to affirmatively state, “there is nothing wrong with the prior art”, pertaining to, or how, banjos are manufactured, in the past, or to-date, they just,“ forgot “forgot to concentrate, on the original tone maker”. ie: the tone-ring, FIG. (8). drawing sheet, numbers (1),(2)&(3).

I have calculated, when a banjo is not equipped, with my, deflecting, and projecting baffles, FIG. (3), loses, (38) percent-of its, volume of sound, and clarity of tone.

Please note: my inventions, can only be installed in the newly, re-designed, spread banjo, (unless designed, to comply.)

### BACKGROUND OF THE INVENTIONS

### ACOUSTIC MUSICAL INSTRUMENTS

SUBJECT: SPREAD BANJO BAFFLES, AND TAILPIECE

My inventions are three concentric baffles, and a non-resonant tail-piece as sembly.

FIG. (1) tail-peace ,(aluminum), drawing sheet (3).

FIG. (3) bottom defecting baffle, (aluminum),″ ″ (1),(2),(3).

FIG. (4) middle detoning baffle, (stainless), ″ ″ ″ ″ ″.

FIG. (5) top detoning baffle, (aluminum) ″ ″ ″ ″ ″.

Please note: all substance matter, used in forming, and shaping, my inventions,--has has never been used inside, or, on the outside of a banjo, for the purpose of defecting, and projecting a sound, that does not have tone.

### REFERENCE TO RELATED DOCUMENTS

I receive musical supply catalogs, yearly, plus, up-dated, quarterly issues, from first quality music: Louisville, Kentucky. also, from Stewart-Macdonalds: Athens, Ohio. Their catalogs,—list all parts, made for a banjo. Nothing listed in the catalogs, resembles the objects, I call my inventions.

My idea in using baffles, FIG., (3). To increase a volume of —sound to the tone ring, FIG. (8) —has never been heard of never, made, and never patented.

Therefore, having never been invented, the invention lack having a related background to the prior art.

### BRIEF SUMMARY OF INVENTION

(Purpose of inventions) my inventions working in sequence, will extract (30) percent more clarity of tone, from the tone ring FIG.(8), —also, boosts the volume of sound, (8) points when using a decibel meter.

“My inventions are”, three concentric baffles, (FIGS.)(3),(4),and (5), - - - THESE baffles of unkind metals, —are joined together to perform as one baffle, defecting and projecting, a volume of sound, without inducing a tone.

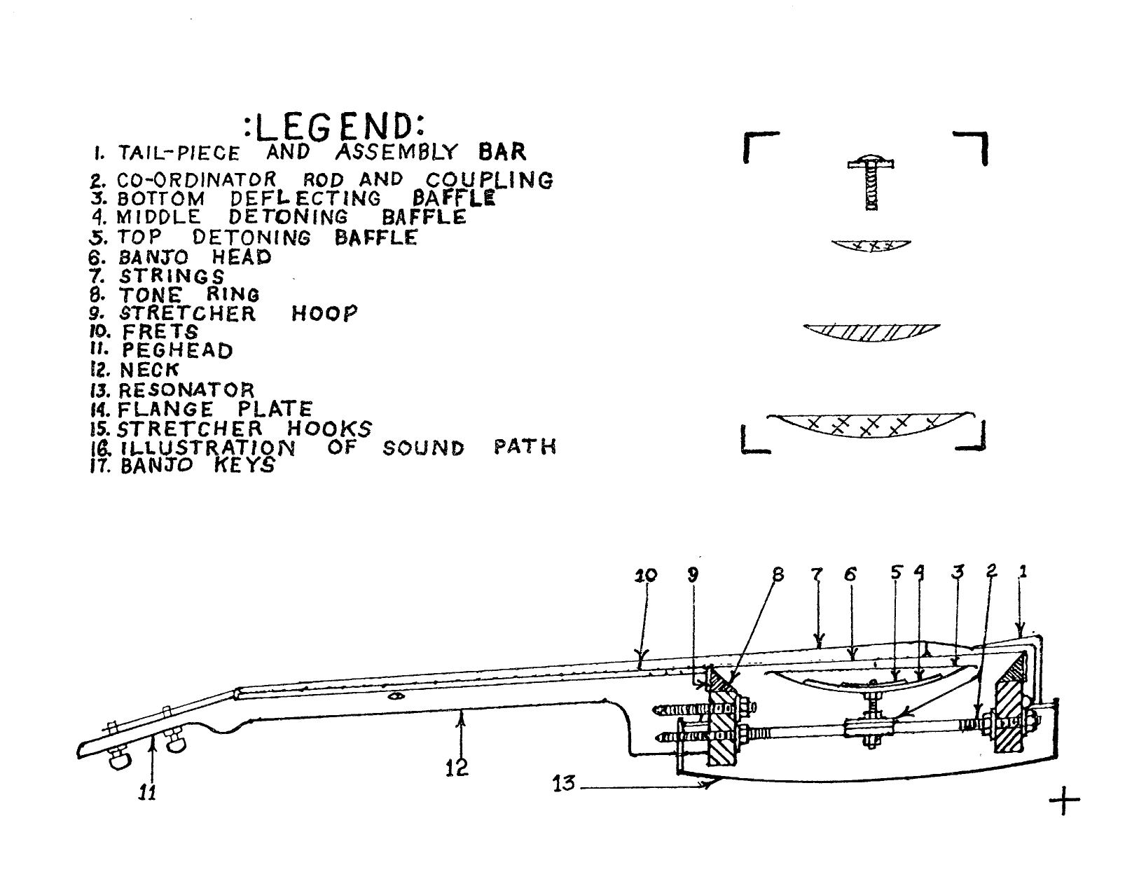

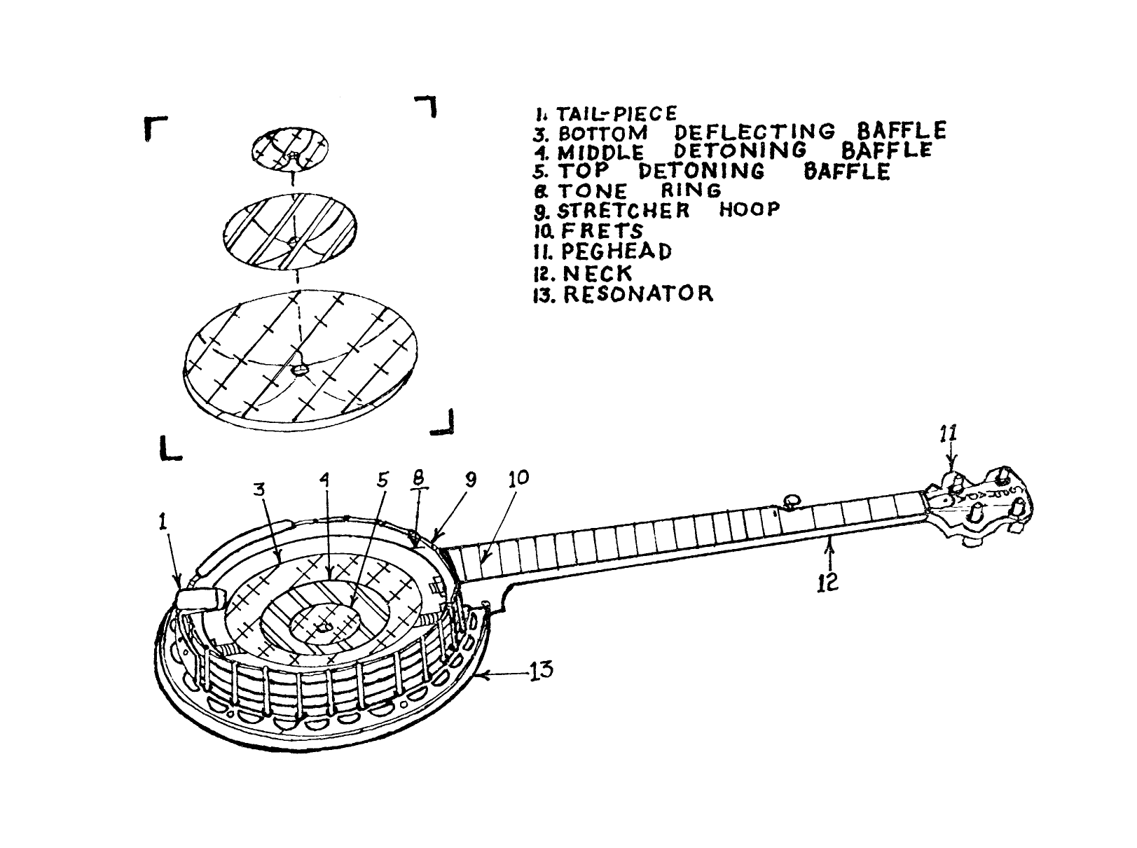

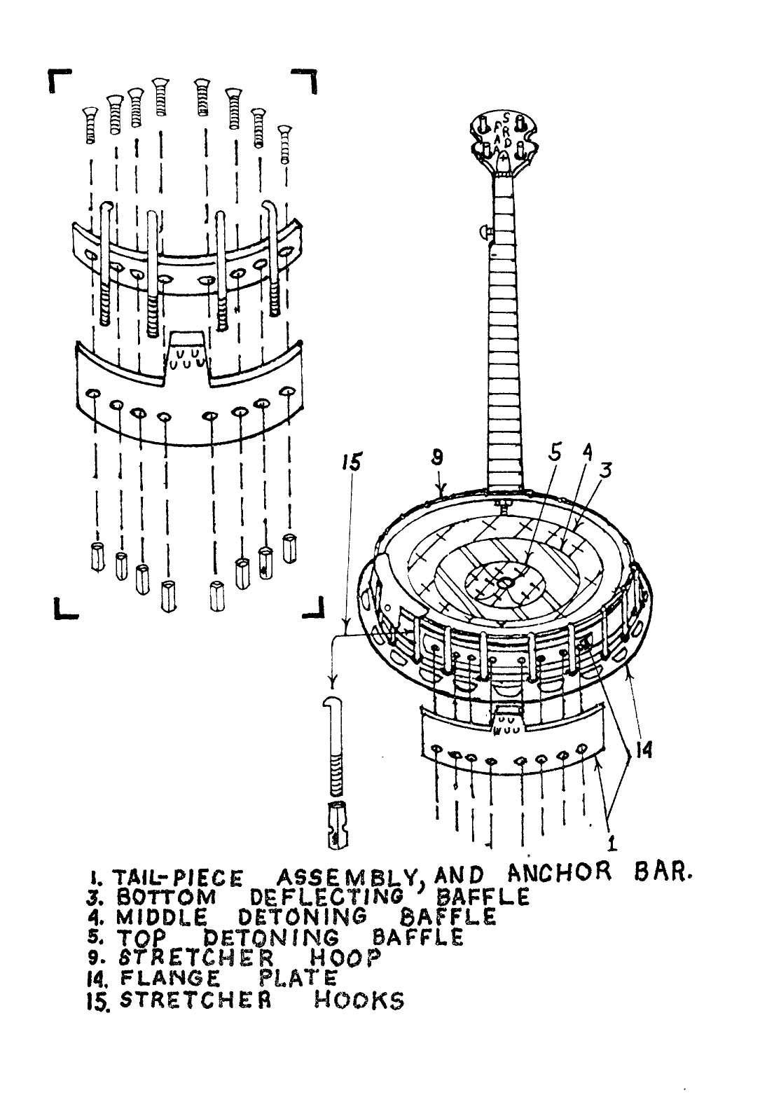

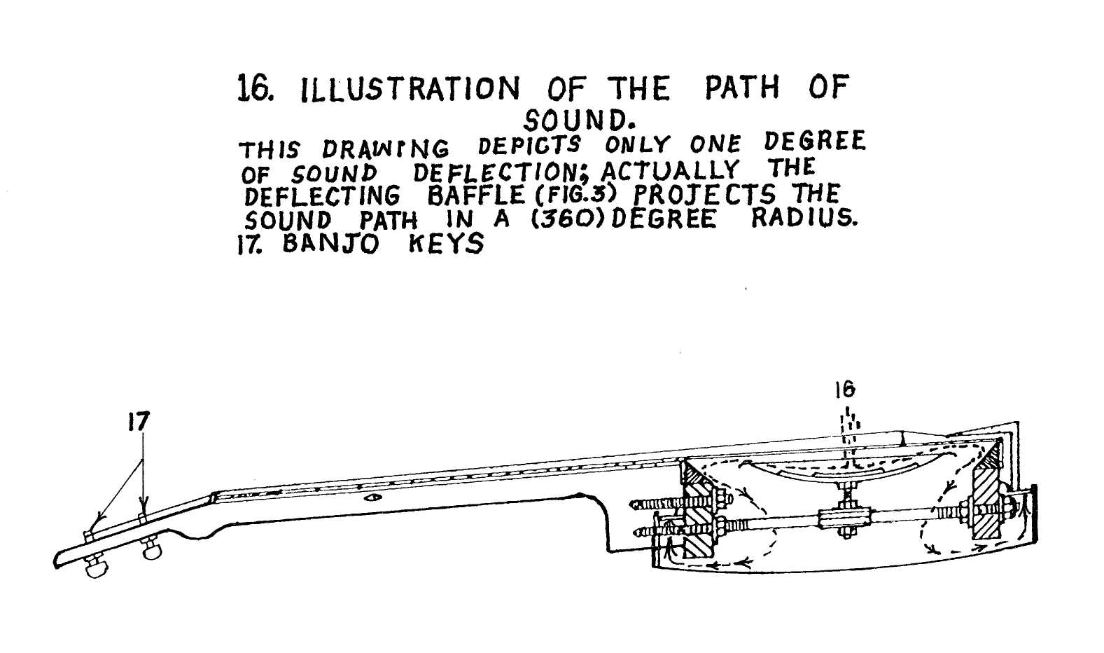

Also, I devised a non-resonant, tailpiece assembly, (FIG. 1), drawing sheet, No. (3), for quelling re-echos, and over tones.

(Example) per se, when the strings FIG. (7), of the banjo, are twanged, activating the banjo head, FIG. (6) thus, producing a volume of sound, that enters the banjo pot, where-upon, striking the deflector baffle, FIG. (3), —illustration FIG. (16) drawing sheet No.(4 ), —hence-forth, the now increased volume of sound, is deflected, and projected in a (360) degree radius, to the tone ring, FIG. (8) having now attained a volume of sound, and a clarity of tone, the sound and tone, moves on, by-passing, the outer edge, of the baffles plane surface, striking the resonator, FIG. (13), bouncing back, and exhausting out, through the, (22) holes of the flange plate, FIG. (14). please note all movements described above, are produced at the rated speed of, sound.

### BRIEF DESCRIPTION OF DRAWING VIEWS

Complete legend listings, on drawing sheet (1) of (4).

“All drawing sheets”, contain reference numbers, respectively, as, they are listed in the legend, of drawing sheet, (1) OF (4). “drawing sheet” No. (1) “cut-away-view”. of baffles assembly,

FIG. (3) bottom deflecting baffle.

FIG. (4) middle detoning baffle.

FIG. (5) top detoning baffle.

Please note; cut-away-view depicts, all baffles assembled, together, installed in the banjo, —also, a exploded view, of the baffles pictured above the banjo.

### DRAWING SHEET (2),″″ ellipse view″.

Portrays a view, of the baffles installed plus, exploded, view, (above).

### DRAWING SHEET,(3)

FIG. (1) Tail-piece assembly, and anchor bar.

Depicts, a moved position, of the tail-piece assembly, below the banjo, plus, the exploded view, —to the left of the banjo.

### “DRAWING SHEET,(4) ”

FIG. (16) illustrates, the defection, and projection, of sound, moving in a (360) degree radius.

Please note; this page refers only, to my new inventions. All legend reference numbers, will be used in paragraph form, of the detailed, descriptions of the inventions.

### DESCRIPTION OF LEGEND LISTINGS DEFINED

FIG. (1) Tail-piece, and anchor bar, drawing sheet (3) (invention)

FIG. (2) Co originator rod, and coupling. drawing sheet,(1).

FIG. (3) Bottom deflector baffle, (invention), drawing sheet, (1,2,3.)

FIG. (4) Middle detoning baffle, (invention) ″″″″″″″ ″″″″

FIG. (5) Top detoning baffle, (invention)(1,2,3,) drawing sheet.

FIG. (6) Banjo head, (the sound producer) drawing sheet, (1).

FIG. (7) Banjo strings, (change the pitch of tone) when noted.

FIG. (8) Tone ring, (the tone maker of the banjo)

FIG. (9) Stretcher hoop, (a ring for tightening the banjo head).

FIG. (10) Frets, (when noted) changes the pitch of the strings.

FIG. (11) Peghead, holds the keys, that tune the banjo strings.

FIG. (12) Neck, the finger board, —for nothing the-banjo-strings.

FIG. (13) Resonator: (wooden sound, and tone deflector.

FIG. (14) Flange plate; has (22) holes, to exhaust, sound and tone .

FIG. (15) Stretcher hooks, (tightens head, by pulling stretcher hoop down.

FIG. (16) Illustration of sound path.

FIG. (17) Banjo keys, tunes the strings of the banjo.

### DETAILED DESCRIPTION OF INVENTIONS

### “DESCRIPTION OF THE PREFERRED IMBODIMENT”

My inventions are; three concentric baffles, plus one non-resonant tailpiece assembly.

FIG. (3) Bottom defecting baffle, drawing sheets, −1,2, and 3

FIG. (4) Middle detoning baffle, ″ ″ ″″″″

FIG. (5) Top detoning baffle, ″ ″ ″″″″″

FIG. (1) Non-resonant tailpiece assembly, drawing sheet, No. 3

All three baffles are joined together, as one whole, designed to defect, and project sound, guiding the path of, sound in a (360) degree radius, VI-A the banjo head, FIG. (6) to the tone ring, FIG. (8). Thus, having attained a volume of sound, and a clarity of tone, continues on, by-passing, the outer edge of the baffles plane surface, spreading out striking the resonator, FIG. (13). Bounces back, then exhausts out through, the (22) holes of the flange plate, FIG. (14).

Illustration, FIG. (16) drawing sheet number, (4).

Please note all movement of sound, and clarity of tone. Described in the above paragraph, occurs in sequence, moving, at the rated speed of sound.

Synopsis when using my inventions, the clarity of tone, increases (30) percent, and the volume of sound, (8) points, on the decibel meter.

### DETAILED DESCRIPTION OF THE INVENTION

### “COMPOSITION OF SUBSTANCE MATTER FORMING THE INVENTIONS”

FIG. (3) Bottom defecting baffle (mold casting) aluminum,magnesium, indium, bismuth, and manganese.

Diameter: (7) inches, depth:(⅞) inch, thickness: (5/32) inch.

FIG. (4):“Bottom defecting baffle (die pressed ), stainless steel, iron, chromium. nickel, tellurium, indium.

Diameter: (5,5/16) inches, depth: (⅝″) thickness: (3/64″

FIG. (5) “Top detoning baffle-(die pressed), aluminum, magnesium, indium, tin, very small quantity of copper. Diameter: (4) inches, depth: (15/32″), thickness, (1/32″).

FIG. (1): Drawing sheet (3): tailpiece assembly, and anchor bar. (mold castings), aluminum, indium, magnesium, ,manganese, and bismuth, length: (7) inches, height, (2.4/8″), thickness, (¼″).

FIG. (1): Anchor bare (mold casted), for (contour). aluminum, indium, magnesium, bismuth, manganese. length: (7) inches, width: (9/16) inch: thickness, (⅛), inch.

Length: (7) inches, width: (9/16) inch: thickness, (⅛), inch.

Please note: FIG. (1)** tailpiece assembly, and anchor bar are tempered, to a much higher tensile strength, than FIG. (3): bottom deflecting baffle.

Please note: all banjo parts, ″after they are molded, and die pressed, will be finished in my shop.

1. Please note: all baffles, FIG. (3), (4), and (5), joined together, can be installed without removing the banjo head, FIG. (6) when using, ”A well qualified technician”.
Step (A): Remove resonator, FIG. (13) drawing sheet, (1).
Step (B): Using (stainless) (steel), attachment hardware, slide pre-assembled, baffle assembly, into the banjo pot. and attach to the existing, co ordinator rod, and coupling, FIG. (2) drawing sheet No. (1), adjust baffles, leaving a (5/8″) space, between the baffles plane surface, and the banjo head, FIG. (6).
FIG. (1): Drawing sheet No. (3), ”Tail-piece assembly, and anchor bar”.
This drawing sheet, portrays a moved position, below the, banjo. “The large exploded view”to the left of the banjo, illustrates, the implementation, in sequence, of all, tail--piece parts, to be assembled, and attached to the banjo.
When joining together, two separately, positioned, units of different shapes, on the units working in sequence, requiring the assistance, of each units performance, where-as both units are essential, to achieving the same purposeful goal, of extracting, a volume of sound, and a clarity of tone, from the banjo tone ring FIG. (8). (banjo available for testing).
Please note: when using baffle, FIG. (3), to increase, a force of sound, to the tone ring, FIG. (8), VI-A, the banjo head FIG. (6), my baffle would not perform correctly, if not, using the large (aluminum), tail-piece, FIG. (1), drawing sheet, (3).
(Example) when the banjo strings, FIG. (7) are plucked, the volume of sound is activated, and increased, by the, banjo head. FIG. (6), most of the force of sound, strikes the, baffle deflector, FIG. (3), located (⅝″), below the banjo head,
FIG. (6), on the inside, of the banjo pot, the baffle then, projects the sound, in a (360) degree radius, to the tome ring, FIG. (8), “please note”: while this movement of sound, is happening. A small amount of sound, back-lashes, causing the, strings FIG. (7), to reverberate, the inducing an unwanted echo.
(Inessence):the prior art brass tail-piece, would not work. only then, did I design, and have (moled), a large, thick, aluminum tail-piece,“that works perfectly”.
The tail-piece is unique, the reason for its shape, and size,
(A): It is attached only, to the four stretcher hooks.
(B); It does not touch the stretcher hoop.
(C): It does not need, a tail-piece bracket.
(D): It is-non-resonant because of its size.
When designing the tail-piece, in this fashion, I actually, did not know the ending result. I only know, I had to have, a direct path of sound, from the starting point, and to the, ending point, of each note plucked, on the strings, FIG. (7) when using the baffle assembly, FIG. (3), in the banjo.
Please note: each of these inventions, work together, each in sequence, giving assistance relative to, controlling, sound within the banjo, this was my absolute reason, for, inventing all units.
“Example” per-se the tail-piece, would not be, a practical, purchase, unless, the baffle assembly, was purchased, also.
Please note: the larger deflecting baffle, FIG. (3), and the tail-piece assembly, FIG. (1) contain the same composition, of matter, and both are (mold-castings).
subject: installing inventions, in sprada banjo. pleases motel all baffles, FIG. (3), (4), and (5), joined together, can be installed without removing the banjo head, FIG. (6)
when using, “a well qualified technician”.
step (A): remove resonator, FIG. (13) drawing sheet, (1).
step (B): using (stainless) (steel), attachment hardware, slide pre-assembled, baffle assembly, into the banjo pot, and attach to the existing, co ordinator rod, and coupling, FIG. (2) drawing sheet No. (1), adjust baffles, leaving a (⅝″) space, between the baffles plane surface, and the banjo head, FIG. (6).
FIG. (1): drawing sheet No. (3), “tail-piece asselmbly, and anchor bar”.
this drawing sheet, portrays a moved position, below the, banjo.
“The large exploded view”to the left of the banjo, illustrates, the implementation, in sequence, of all, tail-piece parts, to be assembled, and attached to the banjo.
(Joiner of inventions in one application).
Should my inventions, fail to fulfill, the requirements, of joiner, in accordance to, (37 OFR, 1.141(a)(b) & (1.42(a)(b)
There′force, requiring restriction, id distinction is evident, please restrict, tail-piece assembly, FIG. (1) drawing, sheet, No. (3). (Please note): may financial status, will allow me to pay, for, (two inventions), (that are positioned separately), in one utility application, for examination, if required my financial status, will not, allow me to pay, two, issues fees, of two separate, “utility patents”:
